(19) United States
(12) Patent Application Publication
(10) Pub. No.: US 2026/0145996 A1
(43) Pub. Date: May 28, 2026

(54) ELECTROCHROMIC GLAZING

(71) Applicant: SAINT-GOBAIN GLASS FRANCE, COURBEVOIE (FR)

(72) Inventors: Anne PENILLARD, AUBERVILLIERS (FR); Pascal NAEL, AUBERVILLIERS (FR); Nicolas CHEMIN, AUBERVILLIERS (FR); Denis GUIMARD, AUBERVILLIERS (FR); Amaury PATISSIER, AUBERVILLIERS (FR)

(21) Appl. No.: 19/120,605

(22) PCT Filed: Oct. 10, 2023
(86) PCT No.: PCT/FR2023/051572

§ 371 Date: Apr. 11, 2025

(30) Foreign Application Priority Data
Oct. 13, 2022 (FR) FR2210516

(51) Int. Cl. C03C 17/36

(52) U.S. Cl. CPC C03C 17/366; C03C 17/3626; C03C 17/3644; C03C 17/3649; C03C 17/3681; C03C 2217/216; C03C 2217/231; C03C 2217/256; C03C 2217/261; C03C 2217/281; C03C 2217/948; C03C 2218/156

(57) ABSTRACT

A material includes a substrate coated with a first conductive coating includes, starting from the substrate a first dielectric coating, a silver-based metal functional layer, a blocking layer located immediately in contact with a silver-based metal functional layer, at least one zinc-based metal layer located above or below this silver-based metal functional layer, directly in contact therewith or separated by one or more layers which have a total thickness of less than or equal to 20 nm, and a second dielectric coating including at least one conductive oxide layer, the sum of the thicknesses of the conductive oxide layers in the second dielectric coating being greater than 30 nm.

The present invention relates to the field of electrochromic glazings (EC). The invention relates in particular to an electroconductive coating for an electrochromic device comprising a silver-based metal functional layer with improved electrochemical properties.

Electrochromic devices, and in particular electrochromic glazings, are systems capable of modulating their optical response, in the visible or infrared range, under the action of an electrical voltage, thus making it possible to obtain easily adjustable electrically controlled coatings.

Electrochromic devices are known to feature an electrochromic system comprising a succession of at least five layered elements essential for device operation, that is, reversible color change following the application of an appropriate supply of power. These five layered elements are as follows:
a first transparent electroconductive coating,
a first active layer acting as an electrode,
an electrolyte layer,
a second active layer acting as a counter-electrode, and
a second transparent electroconductive coating.

At least one active layer is based on an electrochromic material.

These five layered elements are generally in contact with one or two transparent substrates.

Electrochromic systems fall into three categories:
“all-solid” inorganic technology,
“hybrid” technology
“all-polymer” technology.

In “all-solid” electrochromic systems, all layers are made of solid inorganic materials. These systems can comprise a single substrate. Examples of all-solid EC systems are described in patent applications EP-867 752, EP-831 360, WO 00/57243 and WO 00/71777.

Hybrid electrochromic systems comprise inorganic active layers framing an electrolyte layer based on an ion-conducting polymer. These systems conventionally comprise two substrates framing the electrochromic system. Examples of hybrid EC systems are described in patent applications EP-382 623, EP-518 754 and EP-532 408.

In “all-polymer” electrochromic systems, the active layers and electrolyte layer are polymer-based.

The phenomenon of coloration/decoloration in the visible range, or changes in optical properties more generally, results from a transfer of charge (ions/electrons) between the two active layers.

An active layer based on an electrochromic material is capable of reversibly inserting ions. When ions migrate to this layer, its optical properties change, and it reversibly passes from a discolored to a colored state. The other active layer can also be based on an electrochromic material.

Inorganic electrochromic materials are mostly transition metal oxides, grouped into two families: cathodically colored oxides, such as tungsten oxide WO₃, which are colored in the reduced state, and anodically colored oxides, such as iridium oxide (IrOx) and nickel oxide (NiOx), which are colored in the oxidized state. Couples of cathodic and anodic electrochromic materials are generally chosen, with, for example, a cathodic material that becomes colored in the inserted state in combination with an anodic material that becomes discolored in the inserted state.

The electrolyte layer must have good ionic conductivity and be electronically insulating. The electrolytes in the electrochromic system ensure the passage of mobile ions within their electrochemical stability range. In theory, all monovalent ions, such as H+, Li⁺, Na+, K+, Ag+, divalent ions such as Zn²⁺ and trivalent ions such as Al³⁺ can be used. Lithium, alkaline or hydrogen salts are particularly suitable.

For example, when a tungsten oxide (WO₃) active layer is in contact with a lithium ion-conducting electrolyte layer, Li⁺ ions are transferred between the electrodes when a voltage is applied. The following electrochemical reaction is observed at the cathode: W⁶⁺O²⁻₃ (transparent)+x Li⁺+x e⁻→Li⁻ₓW⁶⁺₁₋ₓ W⁵⁺ₓO²⁻₃ (blue).

Voltammetry can be used to determine the voltage ranges that provide the best contrast between colored and discolored states. Voltammetric cycles or curves or voltammograms (j=f(V)) consist in tracking the variation in current density j over the swept potential interval. The study of current density variations is significant for the electrochemical behavior of materials. The coloration potentials (Vcoloration), the discoloration potentials (Vdiscoloration) of the material corresponding to oxidation reactions in the anodic part (j>0) or reduction reactions in the cathodic part of the curve (j<0), and the stability ranges can be deduced directly from these curves.

If an electrochromic device is considered comprising a cathodically colored active layer based on tungsten oxide and an electrolyte layer comprising lithium ions, a colored state is observed at 2.3 V and a discolored state at 3.2 V (vs. Li/Li+).

If an electrochromic device is considered comprising an anodically colored active layer based on nickel oxide and an electrolyte layer comprising lithium ions, the oxidation potential associated with lithium ion deinsertion is around 4 V while the decoloration voltage can be adjusted by doping the nickel oxide between 1V and 2.5 V.

If known all-polymer EC systems comprising an electrolyte layer including lithium ions are considered, the voltage range between a less transparent state and a more transparent state is between 2V and 4V vs Li/Li+.

As a result, for these EC systems, the reactions enabling coloration and decoloration take place within a potential window of between 1V and 4V. The materials making up the various layered elements of the electrochromic system must have electrochemical stability ranges greater than the potential windows required to obtain the coloration/decoloration phenomena.

The “voltage stability range” of a material is the potential range to which a material can be exposed without undergoing an oxidation or reduction reaction.

When a material is subjected to an electrochemical potential outside its stability range and in the presence of the corresponding ions, a redox reaction occurs.

In the case of electrochromic systems, the electroconductive coatings are exposed to the electrochemical potentials of the active materials with which they are in contact. This means that the electroconductive coatings of the electrochromic device must be stable within the potential window 2V to 4V, or even 1V to 4V vs Li/Li+. Electroconductive coatings should therefore have an electrochemical stability range relative to the Li+/Li couple, preferably between 1V and 4V. The materials making up these conductive coatings must not undergo any oxidation-reduction reaction in this voltage range.

Known electroconductive coatings include conductive functional layers based on transparent conductive oxide, such as indium-tin layers or fluorine-doped tin layers, or metal functional layers, particularly silver-based.

Electroconductive coatings based on conductive oxide layers, while offering excellent electrochemical stability, do not have sufficient conductive properties at high light transmission (>80%). This results in inhomogeneous switching and/or a switching speed that decreases as the surface area of the EC system increases. Finally, in some applications, such as automotive applications, additional treatment steps such as hardening or bending are sometimes required. These additional steps are likely to alter conductive oxide coatings. In fact, these coatings need to be thick to achieve the desired resistivity values. However, these thick coatings are sensitive to cracking during heat treatment.

Conductive coatings comprising a silver-based metal functional layer offer superior electrical conductivity and high transparency. However, the low electrochemical stability of the silver functional layer limits the use of this type of conductive coating in electrochromic devices. In particular, silver-based conductive coatings undergo oxidation-reduction reactions with respect to the Li/Li+ couple in the 1V-4V range. At low potential, these reactions result in the reduction of Ag material, the formation of metal alloys (such as LiAg), or the production of reduced gas (dihydrogen). At high potential, these reactions lead to oxidation of the Ag+ material, the formation of oxide (AgO) and/or the production of oxidized gas (dioxygen). In the context of high-potential reactions, mention may also be made of the “corrosion” of materials.

Known electroconductive coatings of this type comprise:
optionally a first dielectric layer or first dielectric coating,
a silver-based metal layer,
optionally a blocking layer,
a second dielectric layer or dielectric coating.

Cyclic voltammograms were carried out to determine the voltage stability range of these electroconductive coatings, using a three-electrode set-up with a lithium metal counter-electrode, a lithium metal reference electrode and a working electrode containing the electroconductive coating to be tested. The electrolyte is a LiClO₄/PC solution. The working electrode comprises a 2 mm glass substrate coated with a known silver-based electroconductive coating comprising, starting from the substrate, the sequence (SiN/SnZnO/Al-doped ZnO/Ag). The voltammogram was taken in the 2-4 V potential window relative to Li/Li+ at a scanning speed of 2 mV/s.

No oxidation reaction is observed between 2 V and 3.4 V. A slight increase in current density is observed around 3.4 V vs Li/Li+, followed by a sharp increase around 3.7 V vs Li/Li+. This sharp increase is due to the oxidation of metallic Ag into Ag+ ions, which dissolve in the electrolyte. This demonstrates that such conductive coatings cannot be used in electrochromic devices unless the accessible contrast of the EC device is limited by imposing potentials below 3.7 V. In this case, no complete decoloration or coloration is obtained.

In order to benefit from the improved optical and conductive properties of silver-based electroconductive coatings in electrochromic devices, it is necessary to extend their electrochemical stability range.

The present invention relates to an electroconductive coating comprising a silver-based metal functional layer with improved electrochemical stability. The coating of the invention is particularly suitable for use in electrochromic devices.

The applicant has discovered that the use of certain blocking layers in combination with a zinc- or indium-based metal layer proximate to the silver-based functional layer results in improved electrochemical stability, particularly around 3.7 V vs Li/Li+. This improvement in electrochemical stability makes the agent-based conductive coating suitable for EC applications.

The invention relates to a material comprising a substrate coated with a first conductive coating comprising, starting from the substrate:
a first dielectric coating,
a functional metal layer comprising a silver-based layer,
a blocking layer located immediately in contact with a silver-based metal functional layer, selected from metal layers based on a metal or metal alloy, metal nitride layers, metal oxide layers and metal oxynitride layers, of one or more elements selected from titanium, nickel, chromium, tantalum and niobium, aluminum oxide layers and silicon oxide layers,
at least one zinc- or indium-based metal layer located above or below this silver-based metal functional layer, directly in contact therewith or separated by one or more layers which have a total thickness of less than or equal to 20 nm,
preferably, a second dielectric coating comprising at least one conductive oxide layer, the sum of the thicknesses of the conductive oxide layers in the second dielectric coating being greater than 30 nm, preferably greater than 40 nm.

The invention increases the stability range of the silver-based electroconductive coating above 3.7 V compared with Li/Li+.

The invention also relates to a conductive coating comprising a metal functional layer comprising a silver base layer, preferably transparent, electrochemically stable in the potential window of 2 to 4 V with respect to Li/Li+. The conductive coating includes:
a metal functional layer comprising a silver base layer,
a blocking layer located immediately in contact with a silver-based metal functional layer,
at least one zinc-based metal layer located above or below this silver-based metal functional layer, directly in contact therewith or separated by one or more layers which have a total thickness of less than or equal to 20 nm.

The most advantageous properties of the invention are obtained after high-temperature heat treatment. The electroconductive coating or material of the invention, that is, the substrate coated with the electroconductive coating, preferably undergoes a high-temperature heat treatment, that is, at a temperature above 250° C., preferably above 300° C., 400° C. or 500° C.

The purpose of the blocking layers is to improve the electrochemical properties of the silver layers. The blocking layers are preferably deposited in metallic or nitrided form, based on one or more elements chosen from nickel, iron, zirconium, titanium or tungsten. The purpose of these blocking layers is to protect the silver layer and prevent the diffusion of ions from the active layer, such as Li+ ions.

Without wishing to be bound by any theory, it is likely that part of the zinc or indium metal layer will alloy with the silver, particularly during high-temperature heat treatment. The blocking layer modulates this doping.

Each of these layers contributes to improving the electrochemical stability of the silver-based metal layer. However, the combination of blocking layer and zinc layer leads to the best results in terms of high contrast for the final EC device and electrochemical stability for the electroconductive coating.

The zinc or indium metal layer should be proximate to the silver layer. It can be located above, below or on either side of the silver layer.

Owing to this particular coating structure, it is possible to obtain a transparent conductive coating with an electrochemical resistance compatible with EC systems, while at the same time having high electrical conductivity properties and high light transmission levels, in particular in excess of 60%, 70% or 80%.

The invention also relates to a material with the following characteristic(s):
the blocking layer has a thickness of between 0.1 and 5.0 nm or between 0.5 and 2 mn,
the blocking layer is selected from a titanium nitride layer, nickel- and/or chromium-based metal layers, nickel and/or chromium oxide layers, aluminum oxide layers, silicon oxide layers,
the blocking layer is selected from nickel-based metal layers comprising at least 20% by mass of nickel relative to the mass of the nickel-based metal layer,
the zinc- or indium-based metal layer is separated from the silver-based metal functional layer by at least one blocking layer,
the thickness of all layers separating the silver-based metal functional layer from the zinc- or indium-based metal layer is less than or equal to 10 nm,
the zinc- or indium-based metal layer is located above the silver-based metal functional layer,
the thickness of the zinc- or indium-based metal layer is between 0.2 and 10 nm,
the zinc-based metal layers comprise at least 20% by mass of zinc relative to the mass of the zinc-based metal layer,
the second dielectric coating comprises a conductive oxide layer selected from tin indium mixed oxide or zinc oxide doped with aluminum and/or gallium,
the second dielectric coating comprises a conductive oxide layer based on aluminum-doped zinc oxide with a thickness greater than 50 nm,
the first dielectric coating comprises at least one crystallized dielectric layer, in particular based on zinc oxide, optionally doped with at least one other element, such as aluminum,
the first dielectric coating comprises a layer based on aluminum and/or zirconium silicon nitride or oxynitride, and/or a layer based on zinc tin oxide,
the stack has been heat-treated at a temperature above 300° C., preferably 500° C., 550° C. or 600° C.,
the silver-based functional layer comprises zinc,
the substrate is made of glass, in particular soda-lime-silica glass, or of polymeric organic material,
the material further comprises a first active layer comprising an electrochromic material located in contact with the electroconductive coating,
the material further comprises an electrolyte layer located in contact with the first active layer comprising an electrochromic material, preferably the electrolyte is a lithium ionic conduction electrolyte,
the material further comprises a second active layer in contact with the electrolyte layer,
the material further comprises a second electroconductive coating located in contact with the electrolyte layer.

The invention also relates to an electrochromic system comprising:
a material according to the invention comprising a first transparent electroconductive coating,
a first active layer comprising an electrochromic material,
an electrolyte layer,
a second active layer, and
a second transparent electroconductive coating,
optionally a substrate.

The electrochromic material of the active layers can be based on inorganic material such as tungsten oxide, nickel oxide, iridium oxide, cerium oxide or organic material such as electronically conductive polymers like polyaniline or (poly(3,4-ethylenedioxythiophene)) (PEDOT) or Prussian blue. These materials can insert cations, in particular protons or lithium ions.

The electrochromic material of the first active layer can be based on an oxide of an element chosen from tungsten, nickel, iridium, chromium, iron, cobalt or rhodium, or on a mixed oxide of at least two of these elements, in particular mixed nickel and tungsten oxide. It is preferably based on tungsten oxide.

The electrochromic material of the second active layer or counter-electrode is preferably based on an oxide of an element selected from tungsten, nickel, iridium, chromium, iron, cobalt and rhodium, or on a mixed oxide of at least two of these elements, in particular mixed nickel and tungsten oxide. It is preferably based on nickel oxide or iridium oxide (anodic electrochromic material).

If the electrochromic material of the first active layer is tungsten oxide, that is, a cathodic electrochromic material, whose colored state corresponds to the most reduced state, an anodic electrochromic material based on nickel or iridium oxide can be used for the counter-electrode, for example. In particular, this may be a layer of mixed vanadium-tungsten oxide or mixed nickel-tungsten oxide.

The thickness of the active layers is generally between 50 nm and 600 nm, in particular between 150 nm and 250 nm.

The thickness of the electrolyte layer can be between 1 nm and 1 mm. When the electrolyte layer is made of inorganic material, its thickness is preferably between 1 and 300 nm, between 1 and 50 nm or between 1 and 10 nm. When the electrolyte layer is made from polymer material, the thickness thereof is preferably between 100 and 800 μm, or between 100 and 500 μm.

The two electroconductive coatings must be connected to their respective power supply connectors. These connectors, e.g. busbar and wires, are respectively brought into contact with the electroconductive coatings to supply the appropriate power supply.

The invention also relates to an electrochromic system comprising two substrates held together by a housing or frame.

Throughout the description, the substrate according to the invention is regarded as laid horizontally. The electroconductive coating is deposited above the substrate. The meaning of the expressions “above” and “below” and “lower” and “upper” is to be considered with respect to this orientation. Unless specifically stipulated, the expressions “above” and “below” do not necessarily mean that two layers and/or coatings are positioned in contact with one another. When it is specified that a layer is deposited “in contact” with another layer or with a coating, this means that there cannot be one (or several) layer(s) inserted between these two layers (or layer and coating).

All the light characteristics presented in the description are obtained according to the principles and methods described in the European standard EN 410 relating to the determination of the light and solar characteristics of the glazings used in glass for the construction industry.

The preferred characteristics which appear in the remainder of the description are applicable both to the material according to the invention and, where appropriate, to the glazing or to the system according to the invention.

The electroconductive coating is deposited by magnetic-field-assisted cathode sputtering (magnetron method). According to this advantageous embodiment, all the layers of the coating are deposited by magnetic-field-assisted cathode sputtering.

Unless otherwise mentioned, the thicknesses referred to in the present document are physical thicknesses.

The present invention is suitable for a single-layer silver-based functional coating. This solution is also suitable for coatings with several silver-based functional layers, in particular two or three functional layers. The coating comprises at least one or only one silver-based metal functional layer.

The silver-based functional metallic layer comprises, before or after heat treatment, at least 95.0%, preferably at least 96.5% and better still at least 98.0% by weight of silver relative to the weight of the functional layer.

Preferably, the silver-based functional metal layer before heat treatment comprises less than 1.0% by weight of metals other than silver, with respect to the weight of the silver-based functional metal layer.

After heat treatment, the silver-based functional metal layer may comprise a proportion of zinc or indium. Zinc or indium doping can be measured, for example, by ElectroProbe MicroAnalyzer (EPMA) or Atom Probe Tomography.

The thickness of the silver-based functional layer is comprised between 5 to 25 nm.

The zinc-based metal layer is in a dielectric coating in contact with said silver-based metal functional layer. This means that the zinc-based metal layer is not separated from said silver-based metal functional layer by another silver-based metal functional layer.

The presence of a zinc or indium metal layer proximate to the silver layer causes zinc metal elements to migrate into the silver layer, particularly during heat treatment. The presence of a blocking layer in contact with the silver layer seems to slow down the diffusion of zinc or indium metal through the silver layer.

Consider the case where the zinc-based metal layer is located above the silver layer. If metallic zinc elements diffuse at temperatures lower than the heat treatment temperature, in the absence of a blocking overlayer, they can easily penetrate the silver layer without being sufficiently retained. Conversely, when a blocking overlayer is inserted between the silver and zinc layers, the blocking layer can act as a barrier and slow down the diffusion of metallic zinc elements. This preserves metallic zinc elements in the silver layer.

To a lesser extent, the use of a blocking underlayer also performs the function of preventing the diffusion of metallic zinc elements and confining them to the vicinity of the silver layer. Configurations according to this embodiment can be advantageous.

Preferably, the blocking layer is located between the functional layer and the zinc- or indium-based metal layer.

In the following paragraphs, zinc- or indium-based metal layers are defined as they are obtained during deposition, that is, before heat treatment. Insofar as heat treatment induces the migration of metallic zinc elements, it is not possible to determine with certainty, depending on the thicknesses deposited, how this zinc or indium metal layer is modified as a result of heat treatment.

“Metal layer” is understood to mean a layer comprising no more than 30%, 20% or 10% oxygen and/or nitrogen in atomic percent in the layer.

The layers are deposited in metallic form. After deposition and before heat treatment, they should contain no more than 10% oxygen and/or nitrogen. However, depending on the nature of the layer deposited directly on top, these zinc-based metal layers are susceptible to partial oxidation, which can lead to higher proportions of oxygen or nitrogen. However, these proportions are lower than 30% or 20%. In any case, at least part of the thickness of these zinc- or indium-based metal layers is not oxidized or nitrided.

The zinc-based metal blocking layers (before heat treatment) comprise at least 20%, at least 30%, at least 40%, at least 50%, at least 60%, at least 70%, at least 80%, at least 90%, at least 95%, at least 96%, at least 97%, at least 98%, at least 99% or 100% by mass of zinc relative to the mass of the zinc-based metal layer.

The indium-based metal blocking layers (before heat treatment) comprise at least 20%, at least 30%, at least 40%, at least 50%, at least 60%, at least 70%, at least 80%, at least 90%, at least 95%, at least 96%, at least 97%, at least 98%, at least 99% or 100% by mass of indium relative to the mass of the indium-based metal layer.

The zinc-based metal layers can be selected from:
metal layers of zinc,
metal layers of doped zinc,
zinc alloy-based metal layers.

According to the invention, the term “metal layer of zinc” refers to metal layers of pure zinc that may include a few impurities. In this case, the total mass of zinc is at least 99% by mass of the mass of the zinc-based metal layer.

According to the invention, the doped zinc layers comprise at least 90.0%, at least 95%, at least 96%, at least 97%, at least 98% or at least 99% by mass of zinc of the mass of the zinc-based metal layer.

The doped zinc layers can be selected from layers based on zinc and at least one element selected from titanium, nickel, aluminum, tin, niobium, chromium, magnesium, copper, silicon, silver or gold.

According to the invention, the zinc alloy-based layers comprise at least 20%, at least 30%, at least 40%, at least 50%, at least 60%, at least 70%, at least 80% or at least 90% by mass of zinc of the mass of the zinc-based metal layer.

The zinc alloy layers can be selected from layers based on zinc and at least one element selected from titanium, nickel, chromium and tin. Examples include binary zinc-titanium alloys such as Zn₂Ti or ternary zinc-nickel-chromium alloys such as ZnNiCr.

The thickness of the zinc- or indium-based metal layer ranges from 0.2 to 10 nm.

The thickness of the zinc- or indium-based metal layer can be:
greater than or equal to 0.2 nm, greater than or equal to 0.5 nm, greater than or equal to 1.0 nm, greater than or equal to 1.2 nm, or greater than or equal to 1.5 nm, greater than or equal to 2 nm, and/or
less than or equal to 10 nm, less than or equal to 8 nm, less than or equal to 7 nm, less than or equal to 6 nm, less than or equal to 5 nm, or less than or equal to 4 nm.

Preferably, the zinc- or indium-based metal layer(s) are located above the silver-based metal functional layer.

The coating comprises a blocking layer located above and immediately in contact with the silver-based metal functional layer and/or a blocking layer located below and immediately in contact with the silver-based metal functional layer.

Preferably, the zinc- or indium-based metal layer(s) are located above a silver layer and above a blocking layer. In this configuration, the zinc- or indium-based metal layer is located above the silver-based metal functional layer and is separated from this layer by at least one blocking overlayer.

The blocking layers are selected from metal layers based on a metal or on a metal alloy, the metal nitride layers, the metal oxide layers and the metal oxynitride layers of one or more elements selected from titanium, nickel, chromium, tantalum and niobium, such as Ti, TiN, TiOx, Nb, NbN, Ni, NiN, Cr, CrN, NiCr or NiCrN.

When these blocking layers are deposited in the metal, nitride or oxynitride form, these layers can undergo a partial or complete oxidation according to their thickness and the nature of the layers which surround them, for example, during the deposition of the following layer or by oxidation in contact with the underlying layer.

Blocking layers can be selected from:
metal layers, in particular of a nickel-chromium (NiCr) alloy, or of titanium,
metal nitride layers, in particular titanium nitride or nickel and/or chromium nitride.

Advantageously, the blocking layers are metallic layers based on nickel. The metal blocking layers based on nickel may comprise (before heat treatment) at least 20%, at least 30%, at least 40%, at least 50%, at least 60%, at least 70%, at least 80%, at least 90%, at least 95%, at least 96%, at least 97%, at least 98%, at least 99% or 100% by mass of nickel relative to the mass of the nickel-based metallic layer.

The nickel-based metal layers can be selected from:
metal layers of nickel,
metal layers of doped nickel,
nickel alloy-based metal layers.

The metallic layers based on a nickel alloy can be based on a nickel-chromium alloy.

Each blocking layer has a thickness of between 0.1 and 5.0 nm. The thickness of these blocking layers can be:
at least 0.1 nm, at least 0.2 nm, at least 0.5 nm and/or
at most 5.0 nm, at most 4.0 nm, at most 3.0 nm, at most 2.0 nm.

In advantageous embodiments, the coating also comprises a crystallized dielectric layer located below and proximate to the silver layer. These crystallized dielectric layers are generally zinc oxide-based layers.

The zinc- or indium-based metal layer can be located:
above a silver-based metal functional layer, the metal layer of zinc is in contact with the silver-based metal functional layer (Ag/Zn sequence),
above a silver-based metal functional layer, the metal layer of zinc is separated from the silver-based metal functional layer by at least one blocking overlayer (Ag//blocking layer//Zn sequence),
above a silver-based metal functional layer and below and in contact with a conductive oxide layer, the metal layer of zinc is separated from the silver-based metal functional layer by at least one blocking overlayer (Ag//blocking layer//Zn//conductive oxide layer sequence),
below a silver-based metal functional layer, the metal layer of zinc is in contact with the silver-based metal functional layer (Zn/Ag sequence)
below a silver-based metal functional layer, the metal layer of zinc is separated from the silver-based metal functional layer by at least one blocking underlayer (Zn//Blocking layer/Ag sequence),
below a silver-based metal functional layer and above and in contact with a crystallized dielectric layer, the metal layer of zinc is in contact with the silver-based metal functional layer (Crystallized layer/Zn/Ag sequence),
below a silver-based metal functional layer and above and in contact with a crystallized dielectric layer, the metal layer of zinc is separated from the silver-based metal functional layer by at least one blocking underlayer (Crystallized layer/Zn//Blocking layer//Ag sequence),
below a silver-based metal functional layer and below and in contact with a crystallized dielectric layer, the crystallized dielectric layer is in contact with or separated from the silver-based metal functional layer by at least one blocking underlayer (Zn/Crystallized layer//optionally Blocking layer//Ag sequence).

The physical thickness of all the layers separating the silver-based metal functional layer from the zinc- or indium-based metal layer can be between 0 and 15.0 nm, or between 0 and 10 nm, or between 0 and 5 nm, between 0.2 and 5 nm, between 0.5 and 3 nm, or between 0.8 and 1.5 nm.

The thickness of all the layers separating the silver-based metal functional layer from the zinc- or indium-based metal layer can be:
greater than or equal to 0.2 nm, greater than or equal to 0.4 nm, greater than or equal to 0.5 nm, greater than or equal to 1 nm, greater than or equal to 2 nm, greater than or equal to 3 nm, greater than or equal to 4 nm, greater than or equal to 5 nm, greater than or equal to 6 nm, greater than or equal to 7 nm, greater than or equal to 8 nm, or greater than or equal to 9 nm, and/or
less than or equal to 20 nm, less than or equal to 15 nm, less than or equal to 13 nm, less than or equal to 12 nm, less than or equal to 11 nm, less than or equal to 10 nm, less than or equal to 9 nm, less than or equal to 8 nm, less than or equal to 7 nm, less than or equal to 6 nm, less than or equal to 5 nm, less than or equal to 4 nm, less than or equal to 3 nm, less than or equal to 2 nm, less than or equal to 1.5 nm.

The configuration in which the zinc- or indium-based metal layer is located above and separated from the silver-based metal functional layer by a blocking overlayer appears to yield the best results.

It is also possible to use a blocking underlayer in these configurations. The use of a blocking underlayer improves the mechanical resistance. In this case, a blocking underlayer is combined with a zinc- or indium-based metal layer located above and in direct contact with said silver layer, or separated from the silver layer by a blocking overlayer.

According to the invention, a “layer located proximate to” is understood to mean a layer located, in increasing order of preference, less than 15 nm, less than 10 nm, less than 5 nm, less than 4 nm, less than 3 nm, less than 2 nm from another layer.

The following embodiments are particularly advantageous, as they yield the best results:
the zinc- or indium-based metal layer is located proximate to the silver layer, and/or
the zinc- or indium-based metal layer is separated from the silver layer by at least one blocking layer, and/or
the zinc- or indium-based metal layer is located above the silver layer, and/or
the coating comprises a blocking layer immediately above and in contact with the silver-based metal functional layer.

To be effective, zinc- or indium-based metal layers must allow the diffusion of zinc or indium metal elements into the silver layer. It is likely that if these zinc layers are separated from the silver layer:
by one or more excessively thick dielectric layers, e.g. excessively thick zinc-tin oxide layers, and/or
by one or more barrier dielectric layers, such as silicon and/or aluminum and/or zirconium nitride layers,
diffusion of these zinc or indium metal elements will be greatly reduced or even prevented. The zinc- or indium-based metal layer then becomes ineffective from the point of view of improving electrochemical properties.

The electroconductive coating may comprise one or more zinc- or indium-based metal layers.

The electroconductive coating comprises at least one functional layer and at least two dielectric coatings comprising at least one dielectric layer, so that each functional layer is placed between two dielectric coatings.

“Dielectric coating” within the meaning of the present invention should be understood as meaning that there may be just one layer or several layers of different materials inside the coating. A “dielectric coating” according to the invention predominantly comprises dielectric layers. However, according to the invention, these layers can also comprise layers of another nature, particularly absorbent layers, for example absorbent metal layers.

A “same” dielectric coating is considered to be one that is located:
between the substrate and the first functional layer,
between each silver-based metal functional layer,
above the last functional layer (furthest from the substrate).

“Dielectric layer” within the meaning of the present invention should be understood as meaning that, from the perspective of its nature, the material is “nonmetallic”, that is, is not a metal. In the context of the invention, this term denotes a material having an n/k ratio, over the whole visible wavelength range (from 380 nm to 780 nm) of equal to or greater than 5. n denotes the real refractive index of the material at a given wavelength and k represents the imaginary part of the refractive index at a given wavelength; the ratio n/k being calculated at a given wavelength which is identical for n and for k.

The thickness of a dielectric coating corresponds to the sum of the thicknesses of the layers constituting it.

The coatings have a thickness of greater than 15 nm, preferably between 15 and 200 nm.

The dielectric layers of the coatings having the following characteristics, alone or in combination:
they are deposited by sputtering assisted by a magnetic field,
they are selected from the oxides or nitrides of one or more elements chosen from titanium, silicon, aluminum, zirconium, tin, indium and zinc,
they have a thickness greater than 2 nm, preferably between 2 and 100 nm.

The dielectric coating above the silver-based metal functional layer must be sufficiently conductive for the electroconductive coating to retain its electrode function.

The dielectric coating above the silver-based metal functional layer comprises at least one conductive oxide layer. Conductive oxide layers are selected from mixed tin and indium oxide, indium oxide doped with tin (ITO “Indium Tin Oxide”), doped zinc oxide such as zinc oxide doped with aluminum (AZO) and/or gallium, doped ruthenium oxide and fluorine-doped tin oxide (SnO2:F).

Preferred materials are indium tin oxide (ITO) or zinc oxide doped with aluminum and/or gallium.

The sum of the thicknesses of all the conductive oxide layers in the dielectric coating directly above the silver-based functional layer is greater than 50 nm or greater than 60 nm.

The sum of the thicknesses of all the conductive oxide layers located in the dielectric coating directly above the silver-based functional layer is less than 150 nm, less than 100 nm, or less than 80 nm.

Preferably, the dielectric coating located directly above the silver-based metal functional layer comprises at least one conductive oxide layer with a thickness greater than 50 nm or 60 nm.

Preferably, the dielectric coating located directly above the silver-based functional layer comprises at least one conductive oxide layer based on aluminum-doped zinc oxide with a thickness greater than 50 nm or 60 nm.

According to one embodiment, the dielectric coating can comprise at least two layers, a layer of aluminum-doped zinc oxide and a layer of mixed indium tin oxide (ITO).

According to the invention, indium tin oxide (ITO) is understood to mean a mixed oxide or mixture obtained from indium (III) oxide (In2O3) and tin (IV) oxide (SnO2), preferably in mass proportions of between 70 and 95% for the first oxide and 5 to 20% for the second oxide. A typical mass ratio is around 90% In2O3 for around 10% SnO2.

According to the invention, the zinc oxide-based conductive oxide layers may comprise at least 50%, at least 60%, at least 70%, at least 80%, at least 90%, at least 95% by mass of zinc compared to the total mass of all the elements forming the zinc oxide-based layer excluding oxygen and nitrogen. To be sufficiently conductive, the zinc oxide-based layers are doped with at least one other element, known as a “doping element”. The layers based on zinc oxide may therefore comprise one or more doping elements selected from aluminum, titanium, niobium, zirconium, magnesium, copper, silver, gold, silicon, molybdenum, nickel, chromium, platinum, indium, tin and hafnium, preferably aluminum.

The conductive layers based on doped zinc oxide may comprise:
at least 1%, at least 2% or at least 5%, and/or
at most 15% or at most 10%,
by mass of doping elements relative to the total mass of all the elements constituting the zinc oxide layer, excluding oxygen and nitrogen.

The dielectric coating beneath the silver-based metal functional layer need not necessarily be conductive. Advantageously, it can comprise a crystallized layer, also known as a stabilizing or wetting layer. “Stabilizing layer” is understood to mean a layer made of a material capable of stabilizing the interface with the functional layer. These layers are generally based on zinc oxide.

Zinc oxide-based layers may comprise at least 50%, at least 60%, at least 70%, at least 80%, at least 90%, at least 95%, at least 96%, at least 97%, at least 98%, at least 99%, or 100% by mass of zinc compared to the total mass of all elements forming the zinc oxide-based layer other than oxygen and nitrogen.

In order to be correctly crystallized by magnetron sputtering, the zinc oxide-based layers advantageously comprise at least 80% or even 90% by mass of zinc, relative to the total mass of all the elements constituting the zinc oxide layer, excluding oxygen and nitrogen.

The layers based on zinc oxide may comprise one or more elements selected from aluminum, titanium, niobium, zirconium, magnesium, copper, silver, gold, silicon, molybdenum, nickel, chromium, platinum, indium, tin and hafnium, preferably aluminum.

The layers based on zinc oxide may optionally be doped by means of at least one other element, such as aluminum.

The zinc-oxide-based layer comprises, in increasing order of preference, at least 80%, at least 90%, at least 95%, at least 98%, at least 100% by mass of oxygen relative to the total mass of oxygen and nitrogen.

Preferably, the dielectric coating located directly below the silver-based functional metal layer comprises at least one crystallized dielectric layer, in particular based on zinc oxide, optionally doped using at least one other element, such as aluminum.

These zinc oxide layers have a thickness of:
at least 1.0 nm, at least 2.0 nm, at least 3.0 nm, at least 4.0 nm, or at least 5.0 nm, and/or
at most 25 nm, at most 15 nm, at most 10 nm or at most 8.0 nm.

Preferably, the dielectric coating located directly below the silver-based functional metal layer comprises at least one dielectric layer with a barrier function. Dielectric layers having a barrier function (hereinafter barrier layer) is understood to mean a layer made of a material capable of forming a barrier to the diffusion of oxygen and water at high temperatures, originating from the ambient atmosphere or from the transparent substrate, toward the functional layer. Such dielectric layers are selected from layers:
based on silicon and/or aluminum and/or zirconium compounds selected from oxides such as SiO2, nitrides such as silicon nitride Si3N4 and aluminum nitrides AlN, and oxynitrides SiOxNy, optionally doped with at least one other element,
based on zinc-tin oxide,
based on titanium oxide.

These dielectric layers with a barrier function have, in increasing order of preference, a thickness:
of less than or equal to 40 nm, of less than or equal to 30 nm, of less than or equal to 25 nm, and/or
of greater than or equal to 5 nm, of greater than or equal to 10 nm or of greater than or equal to 15 nm.

Preferably, the first dielectric coating comprises:
a layer based on an aluminum and/or silicon and/or zirconium nitride or oxynitride, and/or
a layer based on a mixed oxide of zinc and tin, and/or
a layer based on a nitride or oxynitride of aluminum and/or silicon and/or zirconium and a dielectric layer based on a mixed oxide of zinc and tin located above, preferably in contact with, the layer based on a nitride or oxynitride of aluminum and/or silicon and/or zirconium.

The layer based on zinc tin oxide can have a thickness of between 2 and 30 nm, preferably between 5 and 20 nm. The layer based on an aluminum and/or silicon and/or zirconium nitride or oxynitride can have a thickness of between 2 and 30 nm, preferably between 5 and 20 nm. The layer based on zinc tin oxide is located below, preferably in contact with, a layer based on zinc oxide.

The substrate coated with the electroconductive coating, or the coating alone, is intended to undergo a heat treatment. However, the present invention also relates to the non-heat-treated material.

The electroconductive coating may not have undergone a heat treatment at a temperature of greater than 500° C., preferably 300° C.

The coating may have undergone a heat treatment at a temperature of greater than 300° C., preferably 500° C.

The heat treatments are selected from an annealing, for example from “Rapid Thermal Process” annealing, such as a laser or flash lamp annealing, a tempering and/or a bending. The rapid thermal annealing is for example described in application WO2008/096089. The heat treatment temperature (at the coating) is greater than 300° C., preferably greater than 400° C. and better still greater than 500° C.

The substrate coated with the coating can be is a bent or tempered glass.

The transparent substrates according to the invention are preferably made of a rigid inorganic material, such as made of glass, or are organic, based on polymers (or made of polymer).

The organic transparent substrates according to the invention can also be made of polymer, and are rigid or flexible. Examples of polymers which are suitable according to the invention comprise, especially:
polyethylene,
polyesters, such as polyethylene terephthalate (PET), polybutylene terephthalate (PBT) or polyethylene naphthalate (PEN);
polyacrylates, such as polymethyl methacrylate (PMMA);
polycarbonates;
polyurethanes;
polyamides;
polyimides;
fluorinated polymers, such as fluoroesters, such as ethylene-tetrafluoroethylene (ETFE), polyvinylidene fluoride (PVDF), polychlorotrifluoroethylene (PCTFE), ethylene-chlorotrifluoroethylene (ECTFE), fluorinated ethylene-propylene copolymers (FEP);
photocrosslinkable and/or photopolymerizable resins, such as thiolene, polyurethane, urethane-acrylate, polyester-acrylate resins, and
polythiourethanes.

The substrate is preferably a sheet of glass or of glass-ceramic.

The substrate is preferably transparent, colorless (it is then a clear or extra-clear glass) or colored, for example blue, gray or bronze. The glass is preferably soda-lime-silica type but it can also be a glass of borosilicate or alumino-borosilicate type.

According to a preferred embodiment, the substrate is made of glass, especially soda-lime-silica glass, or of polymer organic material.

Advantageously, the substrate has at least one dimension greater than or equal to 1 m, even 2 m and even 3 m.

The thickness of the substrate generally varies between 0.05 mm to 19 mm. When the substrate is inorganic, its thickness is preferably between 0.7 and 9 mm, particularly between 2 and 8 mm, or even between 4 and 6 mm. The substrate can be flat or curved, or even flexible. When the substrate is organic, its thickness is preferably between 1 and 2 mm.

### EXAMPLES

### I. Electroconductive Coatings

Electroconductive coatings were deposited by cathode sputtering onto a transparent glass substrate. The glass substrates are 2.1 mm aluminosilicate glass substrates.

The functional layers (F) are layers based on silver (Ag).

The dielectric coatings comprise:
silicon nitride-based layers,
zinc-tin oxide-based layers,
aluminum-doped zinc layers,
indium-tin layers.

The blocking layers are selected from titanium, titanium nitride, nickel-chromium and zinc layers.

The conditions for deposition of the layers, which were deposited by sputtering (“magnetron cathode” sputtering), are summarized in table 1.

TABLE 1

| | | Pressure | |
|---|---|---|---|
| Layer | Target used | Pa | Gas |
| ITO | In₂O₃ 90%, SnO₂ 10% wt | 0.2 | Ar/(Ar + O2) at 99% |
| Zn | Zn | 0.2 | Ar at 100% |
| NiCr | Ni:Cr 80%:20% by weight | 0.2 | Ar at 100% |
| TiN | Ti | 0.1 to 1 | Ar 85% − N2 15% |
| Ti | Ti | 0.1 to 1 | Ar at 100% |
| Ag | Ag | 0.1 to 1 | Ar at 100% |
| SnZnO | Zn:Sn (64:36% by wt) | 0.1 to 1 | Ar/(Ar + O2) at 50% |
| Si3N4 | Si:Al (92:8% by wt) | 0.32 | Ar/(Ar + N2) at 55% |

Table 2 lists the materials and the physical thicknesses in nanometers (unless otherwise indicated) for each layer or coating that forms the coatings based on their position with respect to the substrate bearing the stack (final row at the bottom of the table).

TABLE 2

| Electroconductive coating | | Coating 1 | Coating 6 | Coating 7 | Inv. 4 |
|---|---|---|---|---|---|
| Upper DC | AZO | 60 | 60 | 60 | 60 |
| | Zn | — | — | — | 2 |
| BL | Ti | 0.5 | — | — | — |
| | TiN | — | — | — | — |
| | NiCr | — | 1 | — | 1 |
| | Zn | — | — | 2 | — |
| FL | Ag | 10 | 10 | 10 | 10 |
| Lower DC | AZO | 5 | 5 | 5 | 5 |
| | SnZnO | 5 | 5 | 5 | 5 |
| | Si3N4 | 20 | 20 | 20 | 20 |
| Substrate | glass | 2 mm | 2 mm | 2 mm | 2 mm |

The first dielectric coatings comprise a SiN/SnZnO/ZnO sequence to prevent diffusion of chemical species from the substrate, reduce surface roughness and optimize silver quality.

### II. Determination of Electrochemical Properties

To determine the electrochemical properties of conductive coatings in relation to mobile electrolyte species such as Li/Li+, voltammetric cycles were carried out. To achieve this, the current response resulting from a continuous variation in the potential of the electroconductive coating (used as the working electrode) on which the electrochemical reaction under study takes place is measured.

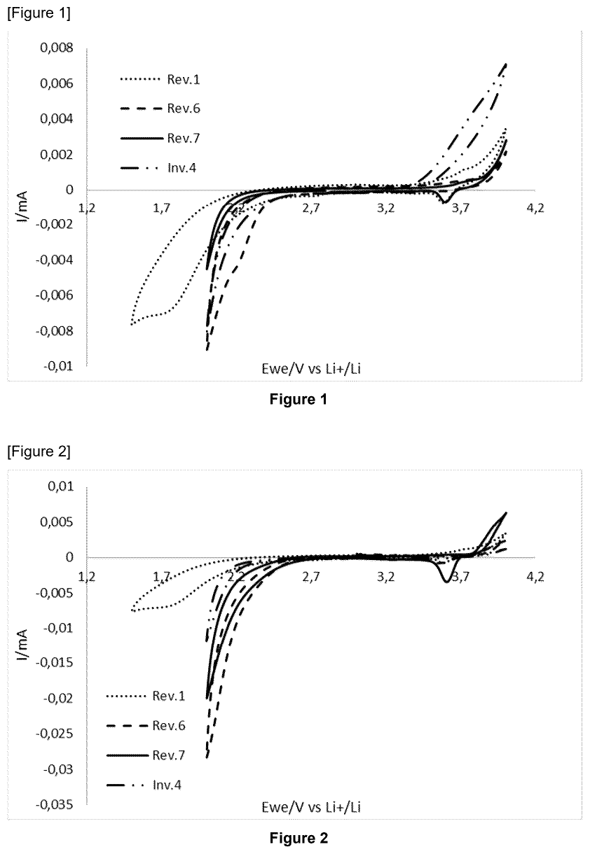

FIGS. 1 and 2 show voltammetric cycles based on a three-electrode set-up with a lithium metal counter-electrode, a lithium metal reference electrode and a working electrode comprising the various electroconductive coatings. The electrolyte is a LiClO4/PC solution.

The voltammograms are taken in the 2-4 V potential window relative to Li/Li+ at a scanning speed of 2 mV/s.

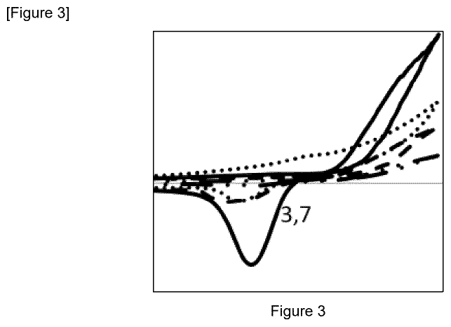

FIG. 3 is an enlargement of FIG. 2 at around 3.7 V.

The electroconductive coatings tested in FIG. 1 have not been heat-treated. The electroconductive coatings tested in FIG. 2 have been heat-treated at 600° C. for 8 minutes.

### 1. No Heat Treatment

In FIG. 1, for coatings Coating 1 and Coating 7 with a titanium or zinc metal blocking layer, respectively, no oxidation reaction is observed between 2 V and 3.4 V. A slight increase in current density is observed around 3.4 V vs Li/Li+, followed by a sharp increase around 3.7 V vs Li/Li+. This sharp increase is due to the oxidation of metallic Ag into Ag+ ions, which dissolve in the electrolyte. This shows that such electroconductive coatings cannot be used in electrochromic devices. The presence of a zinc-based metal layer or a metallic titanium layer proximate to the silver layer alone shows no positive effect. The presence of redox peaks indicates electrode degradation.

Coating 6 with a NiCr blocking layer shows no redox peaks. In the absence of heat treatment, a NiCr-based blocking layer alone improves the stability range of the silver-based electroconductive coating.

Coating Inv.4 according to the invention comprising a NiCr-based blocking layer and a metallic zinc layer does not exhibit redox peaks. An improvement in electrochemical stability can therefore be observed. An increase in current is observed at higher potentials. It could be attributable to the increased conductivity of the coating due to the contribution of the metal layer of zinc.

### 2. After Heat Treatment

After heat treatment, redox peaks are observed for Coating 1, Coating 7 and Coating 6. This means that the electroconductive coating is degraded.

In the case of Coating 7 with a zinc-metal-based blocking layer alone, this phenomenon is particularly significant. An increase in current above 3.4 V is observed, as are redox peaks at 3.6 and 3.7 V. After heat treatment, the presence of a metal layer of zinc alone does not improve the electrochemical stability of silver.

For Coating 6 with a NiCr-based blocking layer, the positive impact of this layer is weaker in the event of heat treatment. Indeed, although the increase around 3.4 V is small, reduction peaks at 3.6 V compared to Li+/Li are observed, corresponding to silver degradation.

The best results are obtained with electroconductive coating Inv.4 of the invention. Neither redox peaks nor voltage rise are observed at high potentials.

The combined effect of a blocking layer and a metal layer of zinc shows a strong improvement in the electrochemical stability of silver. There is very little current rise above 3.4 V and no redox peak.

The effect obtained by the particular combination of the invention is superior to the effects obtained individually. A zinc metal blocking layer alone does not improve the electrochemical stability of silver. A NiCr blocking layer does not prevent redox of the silver layer after heat treatment (above 500° C.). Their combination ensures no degradation of the silver layer.

Combining a blocking layer with a metal layer of zinc capable of diffusing and alloying with silver improves the electrochemical stability of the silver-based coating above 3.7V with respect to Li/Li+ after heat treatment.

The invention makes it possible to use the silver-based coating in a high-contrast electrochromic device operating in the 2-4V vs Li/Li+ range.

1. A material comprising a substrate coated with a first conductive coating comprising, starting from the substrate:
a first dielectric coating,
a silver-based metal functional layer,
a blocking layer located immediately in contact with the silver-based metal functional layer, selected from metal layers based on a metal or metal alloy, metal nitride layers, metal oxide layers and metal oxynitride layers, of one or more elements selected from titanium, nickel, chromium, tantalum and niobium, aluminum oxide layers and silicon oxide layers,
at least one zinc- or indium-based metal layer located above or below the silver-based metal functional layer, directly in contact therewith or separated by one or more layers which have a total thickness of less than or equal to 20 nm,
a second dielectric coating comprising at least one conductive oxide layer, a sum of the thicknesses of the conductive oxide layers in the second dielectric coating being greater than 30 nm.

2. The material according to claim 1, wherein the blocking layer has a thickness of between 0.1 and 5.0 nm.

3. The material according to claim 1, wherein the blocking layer is selected from a titanium nitride layer, nickel-and/or chromium-based metal layers, nickel and/or chromium oxide layers, aluminum oxide layers, silicon oxide layers.

4. The material according to claim 1, wherein the zinc- or indium-based metal layer is separated from the silver-based metal functional layer by at least one blocking layer.

5. The material according to claim 1, wherein a thickness of all the layers separating the silver-based metal functional layer from the zinc- or indium-based metal layer is less than or equal to 10 nm.

6. The material according to claim 1, wherein a thickness of the zinc- or indium-based metal layer is from 0.2 to 10 nm.

7. The material according to claim 1, wherein the second dielectric coating comprises a conductive oxide layer selected from mixed tin and indium oxide, tin-doped indium oxide, doped zinc oxide, doped ruthenium oxide and fluorine-doped tin oxide.

8. The material according to claim 1, wherein the second dielectric coating comprises a conductive oxide layer selected from tin indium mixed oxide or zinc oxide doped with aluminum and/or gallium.

9. The material according to claim 1, wherein the second dielectric coating comprises a conductive oxide layer based on aluminum-doped zinc oxide with a thickness greater than 50 nm.

10. The material according to claim 1, wherein the first dielectric coating comprises at least one crystallized dielectric layer optionally doped using at least one other element.

11. The material according to claim 1, wherein the first dielectric coating comprises:
a layer based on silicon, aluminum and/or zirconium nitride or oxynitride, and/or
a layer based on zinc tin oxide.

12. The material according to claim 1, wherein the conductive coating has been subjected to a heat treatment at a temperature greater than 300° C.

13. The material according to claim 12, wherein the silver-based functional layer comprises zinc.

14. An electrochromic system comprising:
a material comprising a substrate coated with a first conductive coating comprising, starting from the substrate:
a first dielectric coating,
a functional metal layer comprising a silver-based layer,
a blocking layer located immediately in contact with the silver-based metal functional layer, selected from metal layers based on a metal or metal alloy, metal nitride layers, metal oxide layers and metal oxynitride layers of one or more elements selected from titanium, nickel, chromium, tantalum and niobium, aluminum oxide layers and silicon oxide layers,
at least one zinc-based metal layer, located above or below the silver-based metal functional layer, directly in contact or separated by one or more layers whose total thickness is less than or equal to 20 nm,
a second dielectric coating comprising at least one conductive oxide layer, a sum of the thicknesses of the conductive oxide layers in the second dielectric coating being greater than 30 nm,
a first active layer comprising an electrochromic material,
an electrolyte layer,
a second active layer, and
a second transparent electroconductive coating,
optionally a substrate.

15. The material according to claim 10, wherein the at least one crystallized dielectric layer is zinc oxide.

16. The material according to claim 10, wherein the at least one other element is aluminum.

17. The material according to claim 12, wherein the temperature is greater than 500° C.
